(19) United States
(12) Patent Application Publication
(10) Pub. No.: US 2006/0012552 A1
(43) Pub. Date: Jan. 19, 2006

(54) Liquid crystal display with image flicker and shadow elimination functions applied when power-off and an operation method of the same

(75) Inventors: Chia-Cheng Chiu, Jhunan Township (TW); Bo-An Chen, Tianjhong Township (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 11/106,590

(22) Filed: Apr. 15, 2005

(30) Foreign Application Priority Data
Jul. 16, 2004 (TW) 93121341

(51) Int. Cl. G09G 3/36

(52) U.S. Cl. 345/87

(57) ABSTRACT

A liquid crystal display (LCD) with flicker and shadow elimination functions when power-off comprising a LCD panel, a panel power supplier, an image control unit, and a timing control unit is provided. The panel power supplier offers the power needed for starting the LCD panel. The image control unit controls the image input into the LCD panel. The timing control unit connects to the panel power supplier and the image control unit to dominate the operating sequence. An operation method of the apparatus is to provide a designed pattern to the LCD panel, so as to rapidly release the remaining charges in the LC capacitors of the LCD panel.

### FIELD OF THE INVENTION

The present invention relates to a method of improving displaying quality of a liquid crystal display. More particularly, the present invention relates to a method of avoiding flickers and residual images generating at the time of turning on and turning off the liquid crystal display.

### BACKGROUND OF THE INVENTION

Referring to FIG. 1, a single pixel 1 includes a thin film transistor (TFT) 2 and a liquid crystal (LC) capacitor 3. The source of the TFT 2 is electrically connected to the data line 4, and the gate of the TFT 2 is electrically connected to the scan line 5. An electrode layer of the LC capacitor 3 is connected with the drain of the TFT 2. The other electrode layer of the LC capacitor 3 is supplied with a common voltage (V_{com}).

The LC capacitor 3 comprises a common electrode (not shown herein), a pixel electrode (not shown herein) and an LC layer (not shown herein), wherein the LC layer is sandwiched between the common electrode and the pixel electrode. The common electrode is supplied with the V_{com}, and the pixel electrode is fed with an operation voltage (Vₒ). The voltage difference between the V_{com} and the Vₒ generates an electrical field capable of driving LC molecules within the LC layer to align. Generally speaking, certain properties of the LC molecules, e.g. alignments responsive to the electrical field, will be ruined when the polarity of the voltage is fixed. To avoid the phenomenon, accordingly, different polarities of the Vₒ, i.e. the alternating current (AC), are applied to drive the LC molecules.

As shown in FIG. 2, when an LCD displays a static image, the Vₒ applied onto the pixel electrode exhibits positive cycle and negative cycle by turns. The positive cycle indicates the Vₒ is greater than the V_{com}, whereas the negative cycle means the Vₒ is smaller than the V_{com}. To display the static image, the absolute value of the voltage difference exists between the Vₒ and V_{com} has to remain constant. That is, although alignments of the LC molecules alter responsively to the positive cycle and the negative cycle, the transparency of the LC layer will be consistent if the intensity of the electric field generated from the voltage difference is fixed.

Referring to FIG. 3, when the real common voltage (V_{com}) shifts from the ideal common voltage (V_{com}), the absolute value of the voltage difference between the V_{com′} and Vₒ will change correspondingly. For example, when the positive bias is occurring, the absolute value of the voltage difference between the V_{com′} and Vₒ respectively reduces and increase in the positive cycle region and the negative cycle region. In this case, the intensity of the electric field within the LC layer varies with fluctuations of the absolute value. As a result, the transparency of the LC layer cannot maintain consistent. Image flickers thus generate.

It is noted that electrical charges usually remains within the LC capacitor while powering off the display. Accordingly, residual images are generated on the display at the time of turning the display off. Referring to FIG. 1, When the electrical charges within the LC capacitor is not released completely, the bias, e.g. DC-bias, will occur and the V_{com} will be influenced, resulting in the image flickers described above on the LCD panel. In other words, if the electrical charges cannot be eliminated before restarting the display, the image flickers will generate at the time of restarting the LCD panel.

As concluded, the residual charge within the LC layer is needed to be released to avoid the residual images and flickers.

### SUMMARY OF THE INVENTION

The present invention provides an LCD and a method to completely and rapidly release the charge within the LC layer when powering off the LCD, thus preventing residual images and flickers generating at the time of turning off and restarting the liquid crystal display.

The LCD with functions of eliminating flickers and residual images comprises an LCD panel, a power supply, an image control unit and a timing control unit. The power supply provides power to the LCD panel. The image control unit is used to control images input into the LCD panel. The timing control unit connected between the LCD panel and the image control unit. While powering off the LCD, the timing control unit notifies the image control unit to transmit a designed pattern to the LCD panel for rapidly releasing the charge within LC capacitors at a first predetermined timing, and then notifies the power supply to stop providing power to the LCD panel at a second predetermined timing.

The method of preventing the generation of the flickers and the residual images comprises steps of turning off the LCD, providing a signal of a designed pattern to the LCD panel at a first predetermined timing to rapidly release the residual charge within the LC capacitor, and cutting off power supplied to the LCD panel.

### BRIEF DESCRIPTION OF THE DRAWINGS

The foregoing aspects and many of the attendant advantages of this invention will become more readily appreciated and understood by referencing the following detailed description in conjunction with the accompanying drawings, wherein:

FIG. 1 is a typically circuit diagram of a single pixel of an LCD.

FIG. 2 shows an oscillogram of operation voltage when a static image is displayed on the LCD.

FIG. 3 shows an oscillogram of operation voltage when flickers occurs on the LCD.

FIG. 4 shows the LCD in accordance with the present invention.

FIG. 5 shows a flowchart of a preferred method to avoid flickers occurring at the time of restarting the LCD in accordance with the present invention.

FIG. 6 shows an oscillogram regarding panel power and image signal corresponding to FIG. 5.

FIG. 7 shows a flowchart of another method to avoid flickers occurring at the time of restarting the LCD in accordance with the present invention.

FIG. 8A is an oscillogram showing the variation of operation voltage when not providing a designed pattern to an LCD panel in accordance with the present invention.

FIG. 8B is an oscillogram showing the variation of operation voltage when providing a designed pattern to the LCD panel in accordance with the present invention.

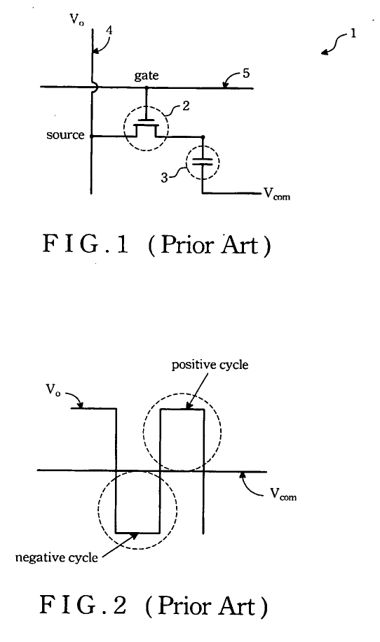

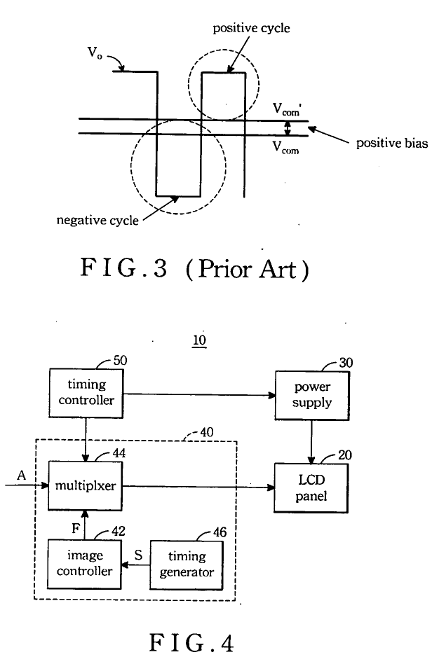

### DESCRIPTION OF THE PERFERRED EMBODIMENTS

The invention discloses a liquid crystal display (LCD) and a method of improving displaying quality of the LCD. The present invention is now described in detail below.

Referring to FIG. 4, a diagram of a preferred embodiment of the LCD 10 is shown. The LCD 10 comprises an LCD panel 20, an image control unit 40 and a timing control unit 50. The LCD panel 20 having a plurality of LC capacitors (not shown herein) is used to display images. The image control unit 40 connecting with the LCD panel 20 controls signals of images and transmits the signals to drivers of the LCD panel 20, such as source drive and gate driver, for generating images on the LCD panel 20. The timing control unit 50 connecting with the LCD panel 20 and image control unit 40 controls the operational sequence and timing of charging and discharging the LC capacitors.

As shown in the figure, the image control unit 40 includes an image generator 42, a multiplexer 44 and a timing signal generator 46. The image generator 42 is used to produce a designed pattern F. The multiplexer 44 connects with the image generator 42 and the timing control unit 50, receiving the designed pattern F and an inputted normal image A. Subsequently, the multiplexer 44 selectively transmitting one of the designed pattern F and the normal image A to the LCD panel 20. The timing signal generator 46 connecting with the image generator 42 provides a timing signal S of the designed pattern F, wherein the timing signal S is used to control scanning speed and displaying duration of the designed pattern F on the LCD panel 20.

The electrical charges usually remain within the LC capacitor of the LC panel 20 at the time of turning off the LCD 10. Therefore, a residual image generates on the LC panel 20 after powering the LCD 10 off. In another aspect, the remaining charges result in flickers when immediately restarting the LCD 10. Accordingly, if the remaining charge can be rapidly and effectively released from the LC capacitor during turning off the LCD 10, the residual image and flickers will be effectively eliminated.

To release the remaining charges within the LC capacitor, the image control unit 40 provides the designed image F to the LCD panel 20 after powering off the LCD 10. The designed pattern F is used to charge and discharge the LCD layer of the LCD panel 20 for rapidly releasing the electrical charges that remains within the LC capacitor. In one preferred embodiment of the present invention, the intensity of the electrical field provided by the designed pattern F is at most 10% of the maximal intensity of original electrical field set to drive the LC molecules within the LC capacitor. In another embodiment, the intensity of the electrical field provided by the designed pattern F is substantially equal to the minimal intensity of original electrical field set to drive the LC molecules within the LC layer. For example, the maximal electrical field indicates a driving voltage at the value of 255 in a 8-bits-per-pixel conventional LCD panel. Yet the intensity of the electrical field provided by the designed pattern F usually varies according to the types of LCDs.

For ensuring the remaining charges within the LC capacitor are completely released, the length of the designed image F ranges from 1 to 100 predetermined frames or about 10 ms to 1000 ms. It is noted that the designed pattern F varies with types of LCD panels. For example, when the LCD panel 20 is a twisted nematic (TN) LCD panel, the designed pattern F is substantially a white image. While the LCD panel 20 is a multi-domain vertical alignment (MVA) LCD panel or an in-plane switching (IPS) LCD panel, the designed pattern F is substantially a black image.

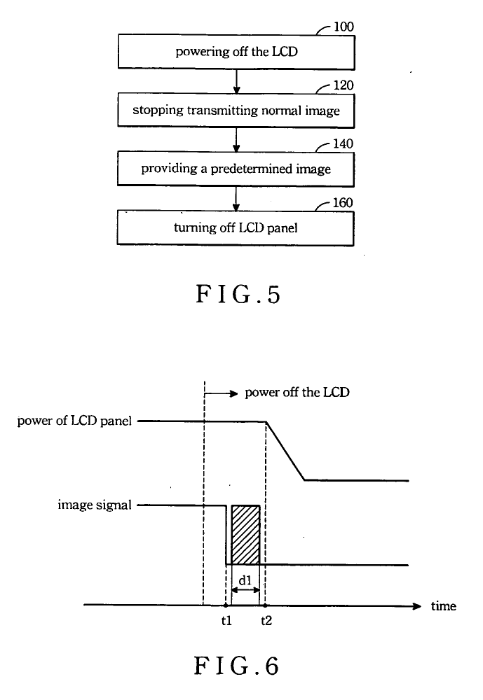

FIG. 5 shows a flowchart of a preferred method to rapidly release the remaining charges within the LC capacitor. Descriptions of FIG. 5 are simultaneously referred to FIG. 4 and FIG. 6. As shown in FIG. 5, the power of the LCD is turned off at first (operation 100). Thereafter, the timing control unit 50 controls the multiplexer 44 of the image control unit 40 to stop sending the normal image A to the LCD panel 20 (operation 120). The timing control unit 50 then notifies the multiplexer 44 of the image control unit 40 at a first predetermined timing t1 to transmit the signal of the designed pattern F generated by the image generator 42 to the LCD panel 20 (operation 140) for rapidly releasing the electrical charges remaining within the LC capacitor. It is noted that the multiplexer 44 will not send the normal image A to the LCD panel 20 again after displaying the designed pattern F on the LCD panel 20. Next, the timing control unit 50 notifies a panel power supply of the LCD panel 20 at a second predetermined timing t2 to stop providing the power (operation 160). In a preferred embodiment of the present invention, the first predetermined timing t1 is set at 100 ms at latest after turning off the LCD; the length of the designed pattern F (d1) is about 10 ms to 1000 ms; the duration between the first predetermined timing t1 and the second predetermined timing t2 is greater than the length of the designed pattern F (d1). Moreover, the second predetermined timing t2 is set at 50 ms at latest after stopping providing the designed pattern F. In other embodiments, these parameters vary with different types of LCDs.

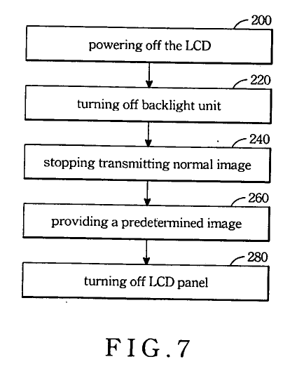

The embodiments illustrated above are applied to a reflective LCD. Referring to FIG. 6 and FIG. 7, other embodiments applied to a transmissive or a transflective LCD are disclosed herein. After powering off the LCD (operation 200), a backlight unit of the LCD is turned off (operation 220). Subsequently, the timing control unit 50 controls the multiplexer 44 of the image control unit 40 to stop sending the normal image A to the LCD panel 20 (operation 240). The timing control unit 50 then notifies the multiplexer 44 of the image control unit 40 at a first predetermined timing t1 to transmit the signal of the designed pattern F generated by the image generator 42 to the LCD panel 20 (operation 260) for rapidly releasing the electrical charges remaining within the LC capacitor. Lastly, the timing control unit 50 notifies a panel power supply of the LCD panel 20 at a second predetermined timing t2 to stop providing the power (operation 280).

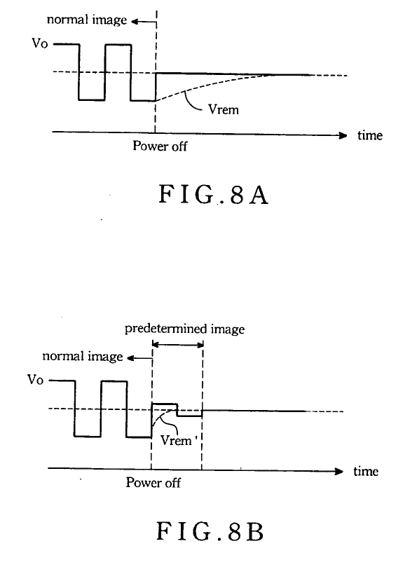

Referring to FIGS. 8A and 8B, an induction of a bias voltage induced by the remaining charges within the LC capacitor and an improvement of the bias voltage are shown respectively. It is clear that the remaining charges (V_{rem′}) within the LC capacitor are rapidly released by displaying the designed pattern F on the LCD panel. That is, the designed pattern F displaying on the LCD panel rapidly charges and discharges the LC capacitor, accelerating the release of the remaining charges within the LC capacitor. In this case, the flickers and residual images generating at the time of turning on and turning off the LCD are effectively eliminated.

The present invention incorporates an additional step, i.e. displaying the designed pattern F on the LCD panel before stopping the power supply to the LCD panel, into the conventionally procedure of turning off the LCD. The step of displaying the designed pattern F on LCD panel can rapidly release the charge remaining within the LC capacitor. Accordingly, the flickers generating at the time of turning on the LCD and residual images generating at the time of turning off the LCD are eliminated, thus improving displaying quality of the LCD. The present invention uses a step of displaying the designed pattern F on LCD panel to improve displaying quality of the LCD. Consequently, the flickers, especially produced at the time of restart the LCD, can be perfectly eliminated. Moreover, the timing control unit of the present invention controls the image control unit and the LCD panel. It is unnecessary to use other devices to have the image control unit provide a designed pattern to the LCD panel at a predetermined timing. As a result, the cost does not increase.

While the preferred embodiment of the invention has been illustrated and described, it is appreciated that modifications and variations can be made therein without departing from the spirit and scope of the invention.

What is claimed is:

1. A liquid crystal display (LCD) system, comprising:
an LCD panel having a plurality of LC capacitors;
a power supply for providing power to the LCD panel;
an image control unit for controlling signals of images inputted into the LCD panel; and
a timing control unit, connected to the image control unit and the LCD panel for controlling operational sequence of the image control unit and the LCD panel, wherein
when the LCD system is turned off, the timing control unit notifies the image control unit at a first predetermined timing to transmit a signal of a designed pattern to the LCD panel for rapidly releasing charge remaining within the LC capacitor, and notifies the power supply at a second predetermined timing to stop providing the power.

2. The liquid crystal display of claim 1, wherein duration between the first predetermined timing and the second predetermined timing is equal to duration of the designed pattern.

3. The liquid crystal display of claim 2, wherein length of the designed pattern ranges from 1 to 100 frames.

4. The liquid crystal display of claim 2, wherein the designed pattern is about 10 ms to 1000 ms in length.

5. The liquid crystal display of claim 1, wherein intensity of electrical field provided by the designed pattern is at most 10% of maximal intensity of original electrical field set to drive the LC molecules within the LC layer.

6. The liquid crystal display of claim 1, wherein intensity of electrical field provided by the designed pattern is substantially equal to the minimal intensity of originally electrical field set to drive the LC molecules within the LC capacitor.

7. The liquid crystal display of claim 1, further comprising a backlight unit configured to provide light to the LCD, wherein the backlight unit is turned off before transmitting the signal of the designed pattern to the LCD panel.

8. The liquid crystal display of claim 1, wherein the image control unit comprises:
an image generator for generating the designed pattern; and
a multiplexer for receiving signals of the designed pattern and a normal image, and selectively outputting one of the signal of the designed pattern and the normal image.

9. A method of eliminating residual images generating at the time of turning off a liquid crystal display (LCD) and flickers generating at the time of restarting the LCD, comprising:
providing a first signal of a designed pattern with a predetermined length to an LCD panel at a predetermined timing after turning off the LCD, wherein intensity of electrical field provided by the designed pattern is at most 10% of maximal intensity of originally electrical field set to drive the LC molecules within the LC layer.

10. The method of claim 9, further comprising turning off a backlight unit of the LCD prior to the predetermined timing.

11. The method of claim 9, wherein intensity of electrical field provided by the designed pattern for driving LC molecules within the LC layer is substantially lower than the minimal intensity of original electrical field set to drive the LC molecules.

12. The method of claim 9, wherein the designed pattern is about 50 ms to 1000 ms in length.

13. The method of claim 9, wherein the predetermined timing is set at 100 ms at latest after turning off the LCD.

14. The method of claim 9, further comprising a step of stopping providing a second signal of a normal image after a completion of displaying the designed pattern.

15. The method of claim 14, further comprising cutting off power supplied to the LCD panel at 50 ms at latest after stopping providing the signal of the designed pattern.

16. A method of eliminating residual images generating at the time of turning off a liquid crystal display (LCD) and flickers generating at the time of restarting the LCD, wherein the LCD includes an LCD panel and a backlight unit, the method comprising:
a) turning off the LCD;
b) providing a signal of a designed pattern to the LCD panel at a first predetermined timing to rapidly release charge remaining within the LC capacitors by charging and discharging the LC capacitors; and
c) cutting off power supplied to the LCD panel.

17. The method of claim 16, further comprising turning the backlight unit off.

18. The method of claim 16, wherein the LCD panel is a twisted nematic (TN) LCD panel and the designed pattern is substantially a white image.

19. The method of claim 16, wherein the LCD panel is a multi-domain vertical alignment (MVA) LCD panel and the designed pattern is substantially a black image.

20. The method of claim 16, wherein the LCD panel is an in-plane switching (IPS) LCD panel and the designed pattern is a nearly black image.
